(19) United States
(12) Patent Application Publication
(10) Pub. No.: US 2010/0153431 A1
(43) Pub. Date: Jun. 17, 2010

(54) ALERT TRIGGERED STATISTICS COLLECTIONS

(76) Inventor: Louis Burger, Escondido, CA (US)

Correspondence Address: JAMES M. STOVER;TERADATA CORPORATION, 2835 MIAMI VILLAGE DRIVE, MIAMISBURG, OH, 45342, US

(21) Appl. No.: 12/332,966

(22) Filed: Dec. 11, 2008

(51) Int. Cl. G06F 17/30

(52) U.S. Cl. 707/769; 707/E17.009

(57) ABSTRACT

In an example embodiment, a method is illustrated as including defining a rule for executing a structured query language (SQL) statement, the rule including a resource threshold. A violation of the rule may be detected during an execution of the SQL statement. Further, SQL execution data is logged in a log table as a result of the rule being violated, the SQL execution data including a statistics collection recommendation. An estimated cost of gathering statistics indicated by the statistics collection recommendation is compared to an estimated resource savings and a data dictionary storing statistics on data objects associated with the SQL statement is updated as a function of the comparing.

### BACKGROUND

Database management systems (DBMS) often execute many queries at a time in systems with finite amounts of resources. In some instances, the DMBS monitors the amount of resources consumed in order to detect poorly performing queries. In some examples, detailed statistics may be gathered on the queries to determine the cause of the problem.

### COPYRIGHT NOTICE

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever.

### BRIEF DESCRIPTION OF THE DRAWINGS

Some embodiments are illustrated by way of example and not limitation in the figures of the accompanying drawings in which:

FIG. 1 is a flowchart diagram illustrating a method to gather statistics on queries, according to an example embodiment;

FIG. 2 is a flowchart diagram illustrating a method to define a log window to gather statistics on queries, according to an example embodiment;

FIG. 3 is a system diagram illustrating an example system to gather statistics on queries, according to an example embodiment; and

FIG. 4 illustrates a computer system, according to an example embodiment.

### DETAILED DESCRIPTION

The following detailed description includes references to the accompanying drawings, which form a part of the detailed description. The drawings show, by way of illustration, specific embodiments in which the invention may be practiced. These embodiments, which are also referred to herein as “examples,” are illustrated in enough detail to enable those skilled in the art to practice the invention. The embodiments may be combined, other embodiments may be utilized, or structural, logical, and electrical changes may be made without departing from the scope of the present invention. The following detailed description is, therefore, not to be taken in a limiting sense, and the scope of the present invention is defined by the appended claims and their equivalents.

In this document, the terms “a” or “an” are used, as is common in patent documents, to include one or more than one. In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.”

In some example embodiments, database products (for example Teradata) and database management systems (DBMS) offer automated system management features that monitor and control resource usage as well as allow users of the system to define rules associated with resources. In some examples, resources may include, but are not limited to one or more central processor units (CPU), random access memory (RAM), read only memory (ROM), hard disk space, input and output operations, or time.

It may be advantageous to have an efficient method to monitor the resource usage of SQL queries and optimize the queries based on collected statistics in response to a resource threshold being breached. To this end, users may define rules on a workload consisting of SQL queries that limit resource usage based on estimated costs appearing within the query optimizer's execution plan or actual resources consumed by a particular query.

In addition, a user may define the action to take when a given rule is violated including the reporting of an exception, often referred to as an alert. In some example embodiments, a DMBS automatically monitors and diagnoses alerts that are logged over a period of time and triggers the appropriate corrective actions. Depending upon the nature of the alert, the action may invoke a physical database tuning tool whose resulting actions or recommendations are intended to alleviate future query performance problems.

An example of such a tool is one that recommends the collection of statistics needed by query optimizers (Optimizer) to accurately estimate costs and choose efficient query optimization plans. The cost of a query may be considered the rate or amount of use of one or more of the system's resources. A simple cost analysis might be the length of the time it takes to execute a query. If a table only contains one row, the time may short for a “SELECT *” style query which will examine every row, but significantly longer if there are thousands or millions of rows. Thus, without knowing the number of rows in a table, a DMBS may have a difficult time predicting the cost of execution, and therefore may not be able to develop an optimized query plan.

Integrating standalone statistics tuning tools into the context of alert based monitoring systems may not be practical as these tools are sometimes resource intensive, and the number of potential alert situations that require statistics tuning may be high. In addition, it may not be optimal and inefficient for the management system to invoke an external tool, examine its recommendations, and then finally execute the needed statistics collections. In an example embodiment, a method is developed whereby a core query processing system determines the set of potentially useful statistics that are missing for a given executed SQL request and includes this information in logged output for alerts. Thus, the statistics may be made available to a monitoring system to examine and potentially act upon.

An additional challenge faced by monitoring subsystems that attempt to perform automatic statistics tuning is deciding at what point to trigger a statistics collection. Collect statistics operations can be very expensive (in terms of resources) to perform because they usually perform a scan and sort on the underlying data. As a result, it may not be cost effective to trigger a statistics collection based solely on a single alert instance. In an example embodiment, the monitoring subsystem may have the ability to examine a series of alerts that occur over a period of time and determine when the cost of the statistics collection will be justified, as will be explored more fully below.

In an example embodiment, one solution to the above described problem is to integrate a “Check Statistics” feature into a database query logging (DBQL) subsystem and implement a cost based diagnosis method that determines when triggered statistics collections are warranted by improving workload performance. The use of the term “Check Statistics” is only used in an exemplary manner to describe the process of recommending statistics. Depending on the DBMS system other terms/options may be used that have the same effect as “Check Statistics.”

In an example embodiment, a DMBS supports the “Check Statistics” option as part of a query capture feature that generates recommendations for collecting statistics, via a “COLLECT STATISTICS” query option on columns and indexes. Statistics may include, but are not limited to, number of rows, number of blocks, average row length, number of distinct values (NDV) in a column, number of nulls in a column, data distribution (histograms), and index statistics such as number of leaf blocks, levels, and clustering factor. These statistics may be stored in a data dictionary at the time they are collected. In general, the quality of recommendations are high as the Optimizer checks the availability of statistics in the data dictionary during the normal course of its optimizations and may determine the missing statistics. In some example embodiments, the “Check Statistics” option may be manually applied to a specified SQL request and the resulting recommendations are stored in a Query Capture Database (QCD) along with other captured plan information.

In an example embodiment, the “Check Statistics” functionality is integrated into the DBQL system so that it may easily and efficiently be leveraged by the monitoring subsystem to diagnose alerts. In some example embodiments, the logging system records information about executed queries and any exceptions that may have occurred. A system's workload monitoring feature may scan such logs to diagnose problems and take corrective action. In an example embodiment, users enable logging by issuing a BEGIN QUERY LOGGING statement with an example as shown below:

```
    BEGIN QUERY LOGGING
    [WITH <logging_option [,logging_option...]>]
    ON <user_list> | ALL;
where each <logging_option> can be one of the following keywords:
    EXPLAIN - log the Explain text for the query
    SQL- log the SQL text of the query
    OBJECTS - log references to tables, columns and indexes
    STEPINFO [AND ALERTS] - log execution step info
    CHECK STATISTICS - logs Optimizer recommended statistics
    ALL - all of the above options
```

This statement supports various logging options, one of which, STEPINFO, logs information about the execution steps for a given query including each step's estimated and actual resource usage. As with “Check statistics,” the terms above are exemplary syntax only and others may be used as one skilled in the art will recognize. The STEPINFO option may be extended with a sub-option AND ALERTS that logs additional information if a given step results in a resource rule violation and subsequent alert. With this sub-option, the log may include all the information necessary to accurately identify those alerts that are potentially the result of physical database design issues.

In an example embodiment, the log will contain the following if the STEPINFO and AND ALERTS are enabled: the category or type of alert and, for those alerts related to performance, the identifier of the workload that the offending query belongs to where workload represents a named set of related SQL statements that perform a specific business function, and the actual or estimated resources consumed in excess of the violated rule expressed in standard Optimizer cost units (e.g., milliseconds).

In example embodiments, the CHECK STATISTICS logging option logs statistics collections (if any) recommended by the Optimizer for the query being logged. The content and behavior of this option may be identical to other uses of CHECK STATISTICS with the only difference being that the recommendations are stored in DBQL log tables rather than QCD tables. In this manner, statistics recommendations may be logged with minimal overhead in terms of query processing performance as the Optimizer is already looking for useful statistics and it requires little effort to record the potentially useful statistics that it did not find in the data dictionary.

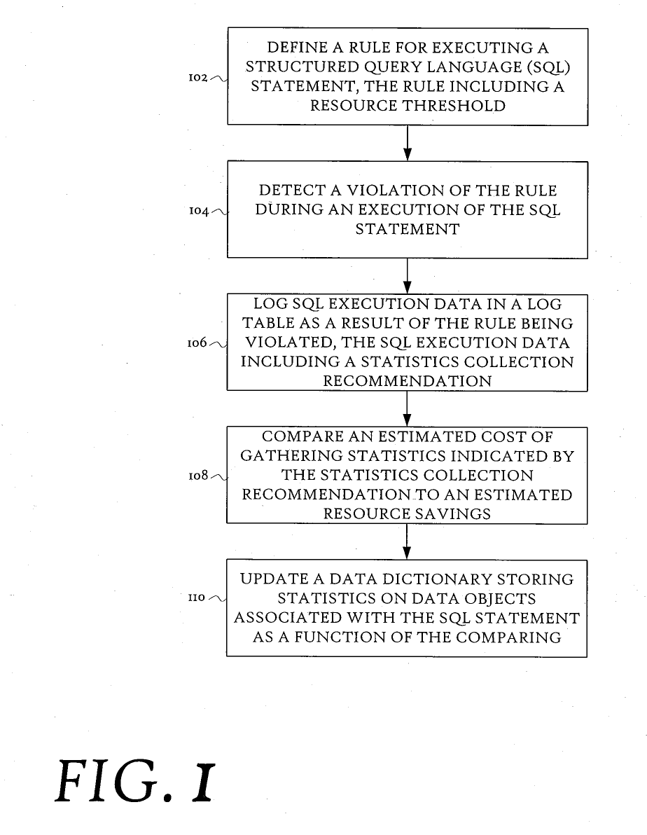

An example method of using a portion of the above features is illustrated in FIG. 1. At block 102, a rule is defined for executing a structured query language (SQL) statement, the rule including a resource threshold. The rule may be defined by receiving input from a graphical user interface presented to user, through a command line interface, or other suitable input means. Preset rules may be shown to the user for quick selection that include example resource thresholds. The interface may also include options for what resources to monitor and an action to implement in response to the rule being violated.

In an example embodiment, the resources threshold may include an execution time such that if a query takes longer than the execution time an alert is generated. In some example embodiments, the resource threshold may include a utilization percentage of a processor during the execution of the SQL statement. In yet another example embodiment, the resource threshold may be based on an estimated cost of executing the SQL statement. More complex rules might be defined that include one or more thresholds. For example, a rule may include a threshold of a one second execution time, but may not issue an alert if the CPU use is above 80%. This may indicate that a delay in execution time may not be because of a design issue, but rather because the system is being heavily used. The combination of resource thresholds may be disjunctive or conjunctive.

At block 104, a violation of the rule is detected during an execution of the SQL statement. In an example embodiment, a monitoring component monitors the execution of the SQL statement and examines the resources being consumed. Upon detecting the violation of one or more resource thresholds the system may look up the proper response. In an example embodiment, the SQL statement includes syntax indicating a preferences for the SQL execution data to include a statistics collection recommendation. At block 106, SQL execution data is logged in a log table as a result of the rule being violated, the SQL execution data including a statistics collection recommendation. In some example embodiments, the execution data includes the rule and the actual amount of resources consumed in excess of the resource threshold. Other data may be logged as indicated by the user or system.

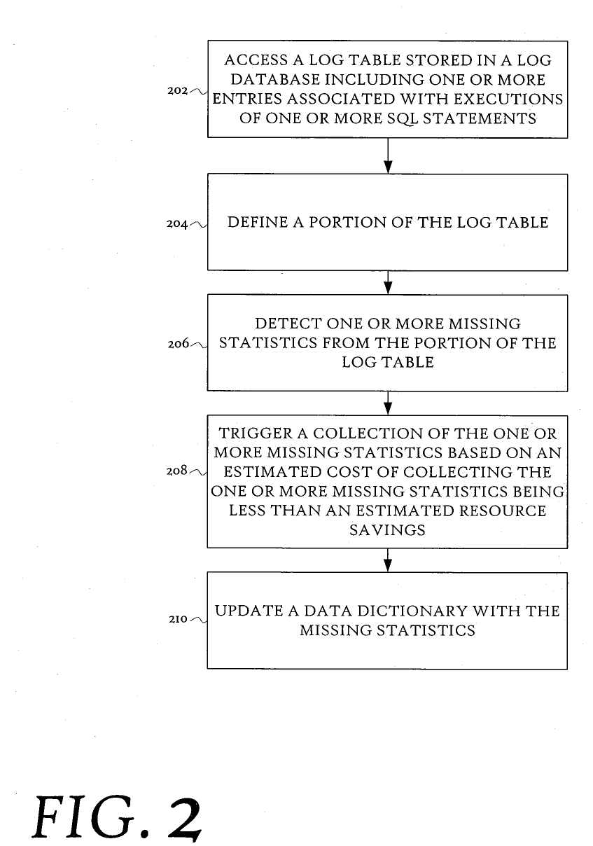

At block 108, an estimated cost of gathering statistics indicated by the statistics collection recommendation is compared to an estimated resource savings. In an example embodiment, the estimated resource savings is equal to the excess resources consumed above the resource threshold. This process is more fully discussed with reference to FIG. 2.

At block 110, a data dictionary storing statistics on data objects associated with the SQL statement is updated as a function of the comparing. For example, in an example embodiment, the statistics indicated by the statistics collection recommendation for database tables associated with the SQL statement are collected based on the estimated resource savings being greater than the estimated cost of gathering the statistics. These statistics may be stored in the data dictionary. In some further example embodiments, an optimization plan for the SQL statement is generated based on the statistics. This may be done, for example, by the Optimizer. The optimization plan may be stored in an optimization database in an entry associated with the SQL statement.

The above described extension to DBQL logging allows the monitoring system to identify alerts that have associated missing statistics as determined by the Optimizer. However, from a diagnosis standpoint, this applies only to a given instance of a SQL request. Before deciding whether or not a potentially expensive COLLECT STATISTICS statement should be triggered, additional diagnosis may be required to estimate the benefit to queries that have experienced similar alerts over a period of time.

In an example embodiment, a portion of the log or “window” is defined that is relevant for determining whether statistics collections are effective. In some example embodiments this window includes all logged queries that meet the following criteria: have one or more associated alerts describing a performance exception as logged by the AND ALERTS option; have one or more statistics recommendations as logged by the CHECK STATISTICS option; and have a log creation timestamp such that the age of the log entry falls within a user configured time window (e.g., occurred within the last 24 hours). In further example embodiments, the criteria that are needed to trigger a complete collection of the statistics are configurable by a user. The triggering criteria may include one or more of the above criteria or additional criteria such as limiting collection of statistics to a specific workload. In other example embodiments, queries that exist outside this defined window may benefit from a given statistics collection, but by limiting the window to the criteria above the system may focus on missing statistics related to resource violations as defined by the user.

In an example embodiment, logged queries that qualify from applying the above criteria are grouped first by their recommended collection column or index and then optionally by their assigned workload identifier. As discussed above, a workload may include one or more SQL queries as defined by a user. A given query may appear in multiple groups if it has more than one statistics recommendation. Within each group, the costs of the excess resources consumed (as logged by the AND ALERT option) may be aggregated for all queries within the group. This aggregated value represents the minimum query cost savings that would need to occur to avoid future alerts on the recommended column or index.

In an example embodiment, an assumption is made that the query savings needed to avoid future alerts could be realized and therefore a statistics collection on a given column or index is cost effective if the collection cost is less than this minimum required query savings amount. This comparison is summarized below in an example formula to trigger the collection of statistics

Triggering Criteria: Collect Statistics Cost<Sum(Required Query Cost Savings)

Although this assumption about query savings may not be realized in all cases, the application of this criteria may disqualify high cost collections. For example, if a series of alerts are exceeding their allowed costs by only a few seconds, it may make no sense to trigger a statistics collection that takes an estimated 10 minutes. In other example embodiments, a user or the system may modify the triggering criteria. For instance, a rule may be defined that establishes that the collect statistics cost be a certain percentage of the query cost savings. A percentage of less than 100% may include less statistics gathering, but a higher assurance there will be a resource savings. In contrast, a percentage of higher that 100% may indicate a willingness to collect potentially wasteful statistics. In an example embodiment, an assumption is made that there is a method to estimate the cost of a given COLLECT STATISITCS statement as are known in the art, with any method being acceptable. However, the effectiveness of the methods described above may vary with the accuracy of the cost estimation. Some factors that may be considered in estimating the cost of gathering statistics may include, but are not limited to, the clock speed of the CPU, the amount of memory available, the number of rows, the number of columns, the type of statistics needed, and indexes already generated that are associated with the tables involved in the cost estimation.

An example method of using a portion of the above features is illustrated in FIG. 2. At block 202, a log table stored in a log database including one or more entries associated with executions of one or more SQL statements is accessed. An entry may be a row in the table that includes one or more columns related to SQL statements such as those described above including, but not limited to, an identification of the SQL statement, an identification of the workload, the type of alert, the amount of resources consumed, and the amount of resources consumed in excess of the resource threshold. At block 204, a portion of the log table is defined. This may be accomplished using a variety of criteria that be conjunctively or disjunctively applied. In an example embodiment, the portion of the log includes one or more SQL statements which include a preference to automatically collect missing statistics. These statements may be those where the user included the COLLECT STATISTICS option. The portion of the log may further include the one or more SQL statements executed which include a preference to log alerts associated with performance. These statements may be those where the user included the AND ALERTS option. The portion of the log may further include the one or more SQL statements executed during a user configured time period, such as 24 hours. In an example embodiment, only those entries that satisfy all three of the above conditions are included in the portion of the log or “window” in the ultimate cost analysis. Other conditions may be applied to further narrow the amount of statistics gathered. For example, a user or the system may exclude those SQL queries where only one alert is present.

At block 206, one or more missing statistics are detected from the portion of the log table. In an example embodiment, the one or more missing statistics include recommended collection columns. At block 208, a collection of the one or more missing statistics is triggered based on an estimated cost of collecting the one or more missing statistics being less than an estimated resource savings. In an example embodiment the estimated cost and the estimated resource savings are measured in seconds. However, other example embodiments may include differing measurement units depending on the resource being consumed. For example, if the resource is related to memory usage or CPU usage, measurements may be taken in megabytes and percent, respectively.

At block 210, a data dictionary is updated with the missing statistics. As with the method described in FIG. 1, an optimization plan for the SQL statements based on the one or more missing statistics may be generated and the optimization plan may be stored in an optimization database in an entry associated with the SQL statements.

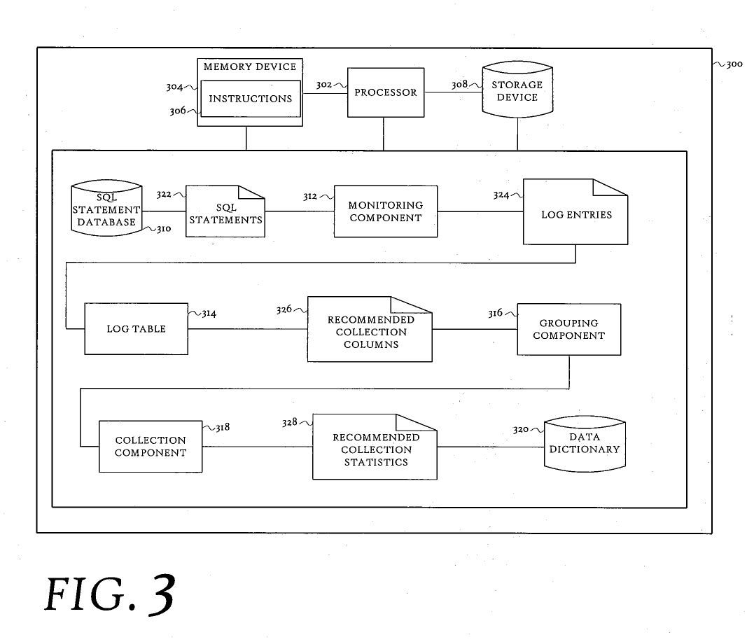

FIG. 3 illustrates a system 300, according to an example embodiment, which may be used to implement the methods and features described above. Illustrated is processor 302, memory device 304 with instructions 306 stored thereon, and storage device 308. Further illustrated are a plurality of software components and databases including SQL statement database 310, monitoring component 312, log table 314, grouping component 316, collection component 318, and data dictionary 320. These components may perform the functions of the subsystems described above. For instance, monitoring component 312 may perform the functions of the monitoring subsystem. While not fully illustrated, the components and databases, processor 302, memory device 304, and storage device 308 may be communicatively coupled to each other such that any one part of the system may communicate with any other part of the system. In some example embodiments, portions of the system are combined. For example storage device 308 may include log table 314.

In an example embodiment, processor 302 executes instructions 306 which are operable to manage other portions of the system. SQL statement database 310 may include one or more SQL statements 322 and resource thresholds associated with the one or more SQL statements 322. An additional database, such as a workload database, may include one or more workloads which group SQL statements from the one or more SQL statements 322 according to a user preference. Monitoring component 312 may generate log entries 324 in log table 314 during the execution of the one or more SQL statements 322. Log entries 324 may include recommended statistics collections based on an SQL statement violating its associated resource threshold. Grouping component 316 may group log entries 324 by recommended collection columns 326 indicated by the recommended statistics collections. Collection component 318 may collect the recommended collection statistics and update data dictionary 320 with recommended collection statistics 328. In an example embodiment, a comparison component may compare an estimated cost of gathering statistics on the recommended collection columns 326 to an estimated resource savings, wherein the estimated resource savings include the sum of resources consumed in excess of the resource thresholds.

The above descriptions illustrate example systems and methods to implement a database feature that accurately identifies missing statistics without introducing significant performance overhead. In some example embodiments, the systems and methods provide an accurate cost based method for determining when it is worthwhile, from the standpoint of responding to system alerts, to trigger statistics collections on one or more of these missing set of statistics. This method may avoid wasteful statistics collections that are not likely to provide a remedy to reported alerts.

Distributed Computing Components

Some example embodiments may include the previously illustrated components (e.g., operations) being implements across a distributed programming environment. For example, operations providing logic functionality may reside on a first computer system that is remotely located from a second computer system containing an Interface or Storage functionality. These first and second computer systems can be configured in a server-client, peer-to-peer, or some other configuration. These various levels can be written using the above illustrated operation design principles and can be written in the same programming language, or a different programming language. Various protocols are implemented to enable these various levels, and operations contained therein, to communicate regardless of the programming language used to write these operations. For example, a module written in C++ using the Common Object Request Broker Architecture (CORBA) or Simple Object Access Protocol (SOAP) can communicate with another remote module written in Java. These protocols include SOAP, CORBA, or some other suitable protocol. These protocols are well-known in the art.

A System of Transmission between a Server and Client

In some embodiments, the above illustrated operations that make up the platform architecture communicate use the Open Systems Interconnection Basic Reference Model (OSI) or the Transmission Control Protocol/Internet Protocol (TCP/IP) protocol stack models for defining network protocols that facilitate the transmission of data. Applying these models, a system of data transmission between a server and client computer system can be illustrated as a series of roughly five layers comprising as a: physical layer, data link layer, network layer, transport layer and application layer. Some example embodiments may include the various levels (e.g., the Interface, Logic and storage levels) residing on the application layer of the TCP/IP protocol stack. The present application may utilize HTTP to transmit content between the server and client applications (e.g., the DBMS and a client computer), whereas in other embodiments another protocol known in the art is used. Content from an application residing at the application layer is loaded into the data load field of a TCP segment residing at the transport layer. This TCP segment also contains port information for a recipient application or a module residing remotely. This TCP segment is loaded into the data field of an IP datagram residing at the network layer. Next, this IP datagram is loaded into a frame residing at the data link layer. This frame is then encoded at the physical layer and the content transmitted over a network such as the Internet, Local Area Network (LAN) or Wide Area Network (WAN). The term Internet refers to a network of networks. Such networks may use a variety of protocols for exchange of information, such as TCP/IP etc., and may be used within a variety of topologies or structures. This network may include a Carrier Sensing Multiple Access Network (CSMA) such as an Ethernet-based network. This network may include a Code Division Multiple Access (CDMA) network or some other suitable network.

A Computer System

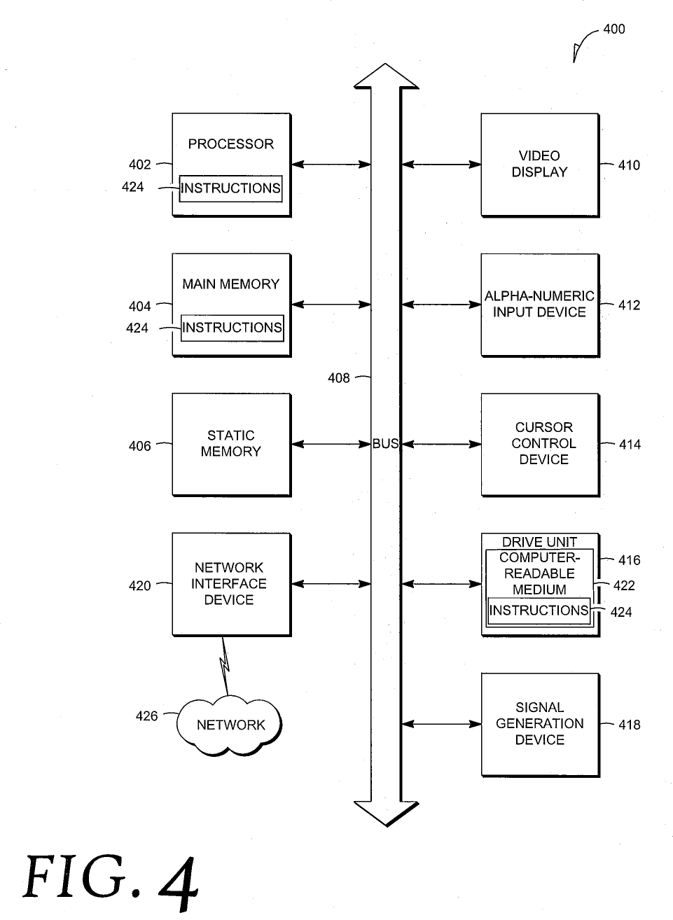

FIG. 4 shows a diagrammatic representation of a machine in the example form of a computer system 400 within which a set of instructions for causing the machine to perform any one or more of the methods, processes, operations, or methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a Personal Computer (PC), a tablet PC, a Set-Top Box (STB), a Personal Digital Assistant (PDA), a cellular telephone, a Web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Example embodiments can also be practiced in distributed system environments where local and remote computer systems which that are linked (e.g., either by hardwired, wireless, or a combination of hardwired and wireless connections) through a network, both perform tasks. In a distributed system environment, program modules may be located in both local and remote memory-storage devices (see below).

The exemplary computer system 400 includes a processor 402 (e.g., a central processing unit (CPU) a graphics processing unit (GPU) or both), a main memory 404 and a static memory 406, which communicate with each other via a bus 408. The computer system 400 may further include a video display unit 410 (e.g., a liquid crystal display (LCD) or a cathode ray tube (CRT)). The computer system 400 also includes an alphanumeric input device 412 (e.g., a keyboard), a cursor control device 414 (e.g., a mouse), a disk drive unit 416, a signal generation device 418 (e.g., a speaker) and a network interface device 420.

The disk drive unit 416 includes a machine-readable medium 422 on which is stored one or more sets of instructions (e.g., software 424) embodying any one or more of the methodologies or functions described herein. The software 424 may also reside, completely or at least partially, within the main memory 404 and/or within the processor 402 during execution thereof by the computer system 400, the main memory 404 and the processor 402 also constituting machine-readable media.

The software 424 may further be transmitted or received over a network 426 via the network interface device 420.

While the machine-readable medium 422 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Method embodiments illustrated herein may be computer-implemented. Some embodiments may include computer-readable media encoded with a computer program (e.g., software), which includes instructions operable to cause an electronic device to perform methods of various embodiments. A software implementation (or computer-implemented method) may include microcode, assembly language code, or a higher-level language code, which further may include computer readable instructions for performing various methods. The code may form portions of computer program products. Further, the code may be tangibly stored on one or more volatile or non-volatile computer-readable media during execution or at other times. These computer-readable media may include, but are not limited to, hard disks, removable magnetic disks, removable optical disks (e.g., compact disks and digital video disks), magnetic cassettes, memory cards or sticks, Random Access Memories (RAMs), Read Only Memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled. Also, in the following claims, the terms “including” and “comprising” are open-ended, that is, a system, device, article, or process that includes elements in addition to those listed after such a term in a claim are still deemed to fall within the scope of that claim.

What is claimed is:

1. A computer-implemented method comprising:
defining a rule for executing a structured query language (SQL) statement, the rule including a resource threshold;
detecting a violation of the rule during an execution of the SQL statement;
logging SQL execution data in a log table as a result of the rule being violated, the SQL execution data including a statistics collection recommendation;
comparing an estimated cost of gathering statistics indicated by the statistics collection recommendation to an estimated resource savings; and
updating a data dictionary storing statistics on data objects associated with the SQL statement as a function of the comparing.

2. The computer-implemented method of claim 1, wherein the resource threshold includes an execution time.

3. The computer-implemented method of claim 1, wherein the resource threshold includes a utilization percentage of a processor during the execution of the SQL statement and the estimated resource savings is equal to excess resources consumed above the resource threshold.

4. The computer-implemented method of claim 1, wherein the SQL statement includes syntax indicating a preference for the SQL execution data to include the statistics collection recommendation.

5. The computer-implemented method of claim 1, wherein the resource threshold is based on an estimated cost of executing the SQL statement.

6. The computer-implemented method of claim 1, wherein the SQL execution data includes the rule.

7. The computer-implemented method of claim 1, wherein the SQL execution data includes an actual amount of resources consumed in excess of the resource threshold.

8. The computer-implemented method of claim 1, wherein updating a statistics database storing statistics on data objects associated with the SQL statement as a function of the comparing includes:
collecting the statistics indicated by the statistics collection recommendation for database tables associated with the SQL statement based on the estimated resource savings being greater than the estimated cost of gathering the statistics;
generating an optimization plan for the SQL statement based on the statistics; and
storing the optimization plan in an optimization database in an entry associated with the SQL statement.

9. A computer-implemented method comprising:
accessing a log table stored in a log database including one or more entries associated with executions of one or more SQL statements;
defining a portion of the log table;
detecting one or more missing statistics from the portion of the log table;
triggering a collection of the one or more missing statistics based on an estimated cost of collecting the one or more missing statistics being less than an estimated resource savings; and
updating a data dictionary with the missing statistics.

10. The computer-implemented method of claim 9, wherein the estimated cost and the estimated resource savings are measured in seconds.

11. The computer-implemented method of claim 9, further including:
generating an optimization plan for the SQL statements based on the one or more missing statistics; and
storing the optimization plan in an optimization database in an entry associated with the SQL statements.

12. The computer-implemented method of claim 9, wherein defining a portion of the log table includes:
selecting the one or more SQL statements which include a preference to automatically collect missing statistics.

13. The computer-implemented method of claim 9, wherein defining a portion of the log table includes:
selecting the one or more SQL statements executed which include a preference to log alerts associated with performance.

14. The computer-implemented method of claim 9, wherein defining a portion of the log table includes:
selecting the one or more SQL statements executed during a user configured time period.

15. The computer implemented method of claim 9, wherein the one or more missing statistics include recommended collection columns.

16. A system comprising:
a processor operable to execute instructions;
a storage device;
a memory device storing instructions, which when executed by the processor are operable to manage:
an SQL statement database including one or more SQL statements and resource thresholds associated with the one or more SQL statements;
a monitoring component to generate log entries in a log table during the execution of the one or more SQL statements, the log entries including recommended statistics collections based on an SQL statement violating its associated resource threshold;
a grouping component to group the log entries by recommended collection columns indicated by the recommended statistics collections; and
a collection component to collect the recommended collection statistics and update a data dictionary with the recommended collection statistics.

17. The system of claim 16, wherein the memory device storing instructions is further operable to manage:
a comparison component to compare an estimated cost of gathering statistics on the recommended collection columns to an estimated resource savings.

18. The system of claim 17, wherein the estimated resource savings include the sum of resources consumed in excess of the resource thresholds.

19. The system of claim 16, wherein the memory device storing instructions is further operable to manage:
a workload database including one or more workloads which group SQL statements from the one or more SQL statements according to a user preference.
